(19) United States
(12) Patent Application Publication
(10) Pub. No.: US 2003/0155443 A1
(43) Pub. Date: Aug. 21, 2003

(54) Disc brake flushing system

(76) Inventor: Wayne Lionel Ace-Kirker, Hamilton (NZ)

Correspondence Address: CHRISTOPHER J. ROURK, AKIN, GUMP, STRAUSS, HAUER & FELD, L.L.P., P O BOX 688, DALLAS, TX, 75313-0688, US

(21) Appl. No.: 10/204,999

(22) PCT Filed: Feb. 22, 2001
(86) PCT No.: PCT/NZ01/00023

(30) Foreign Application Priority Data
Feb. 24, 2000 (NZ) 503048
Nov. 23, 2000 (NZ) 508398

(51) Int. Cl. B05B 1/14

(52) U.S. Cl. 239/550

(57) ABSTRACT

A brake flushing means ifor a vehicle disc brake mechanism, the brake flushing means including a plurality of nozzles (2-7) adapted to direct a flushing fluid at selected components of these disc brake mechanism, and inlet means (8) adatapted to receive flushing fluid and convey the fluid to the nozzles (2-7). In another embodiment fluid supply means and fluid transportation means to transport fluid from the fluid supply means to the inlet means of the brake flushing means are disclosed.

### FIELD OF THE INVENTION

The present invention relates to a vehicle brake flushing system. More particularly it relates to a system for flushing a disc brake mechanism of a vehicle by directing flushing fluid to components of the disc brake mechanism.

### BACKGROUND OF THE INVENTION

Boats are frequently transported to boat ramps on the back of a boat trailer. Once at the boat ramp the trailer is reversed into the water to allow the launching of the boat. Following this, the trailer is generally removed from the water and may remain in the vicinity of a boat ramp until the boat returns.

In the case of marine conditions, such a procedure can be problematic. With braked boat trailers, the brake system of the trailer is in contact with salt water a number of times during the on-loading and offloading of the boat. Furthermore, the brake system of the trailer can remain in contact with salt for long periods if not washed off.

It is found that this phenomenon will often reduce the functioning life of the braking componentry, and overall brake system. Corrosion may result, leading to high maintenance costs and a decreased life span. Furthermore, this phenomenon reduces the integrity and therefore safety of the braking system.

The boating public is aware of this problem and has attempted to improve this situation by manually cleaning the area with fresh water. However, manual methods are reliant on a source of fresh water and can only be successful to a limited degree as they do not allow access to all of the affected areas of a brake system. Furthermore, it is preferable to be able to clean or cool brakes a number of times during the overall process of on- or off-loading.

Power boats are often transported to lakes in various locations. As it is difficult, at present, to thoroughly clean the disc brake mechanism of a trailer, contamination and in particular biological contaminants, may be easily spread from one lake to another. This means the boating public may be unwitting carriers of contamination between lakes.

It is an object of the present invention to provide a vehicle brake flushing system which overcomes or at least ameliorates some of the abovementioned disadvantages, or which at least provides the public with a useful alternative.

Other objects of the invention may become apparent from the following description which is given by way of example only.

### SUMMRY OF THE INVENTION

According to one aspect of the invention there is provided a brake flushing means for a vehicle disc brake mechanism, the brake flushing means including a plurality of nozzles adapted to direct a flushing fluid at selected components of the disc brake mechanism, and inlet means adapted to receive flushing fluid and convey said fluid to the nozzles.

Preferably the brake flushing means may further include a fluid reservoir between the inlet and the nozzles.

In one preferred form the nozzles may be integrally formed with or affixed to the reservoir.

In an alternative form the fluid reservoir may possess nozzle placement sites to which the nozzles may be affixed or engaged.

Preferably, the brake flushing means may have more nozzle placement sites than nozzles.

Preferably, the or each unused nozzle placement site may be sealed or sealable by a plug, wherein the plug blocks the flow of fluid through the nozzle placement site.

Preferably, the nozzles may be made from a pliable material allowing them to be shaped to direct flushing fluid to the selected components of a selected disc brake mechanism.

Preferably the selected components of the disc brake mechanism may be selected from: the piston, the piston seal, the slides, the seal around the slides, the seal around the inner wheel bearing.

Preferably the selected components may include each of the piston, the piston seal, the slides, the seal around the slides, and the seal around the inner wheel bearing.

Preferably the selected components may further include the seal around the caliper housing slides of the one or more disc brake mechanisms.

In one preferred form the fluid reservoir may be formed integrally with the disc brake mechanism.

In an alternative preferred form the brake flushing means may further include attachment means adapted to attach the fluid reservoir to the disc brake mechanism.

According to a second aspect of the invention there is provided a vehicle brake flushing system for a vehicle having one or more disc brake mechanisms, the system including a brake flushing means (which includes a plurality of nozzles and an inlet means) associated with the or each disc brake mechanism, fluid supply means at an accessible point on the vehicle, and fluid transportation means to transport fluid from the fluid supply means to the inlet means of the or each brake flushing means.

Preferably the vehicle may be a trailer, having a tow coupling end and a loading end; and including one or more disc brake mechanisms.

In one embodiment of the second aspect of the invention the fluid supply means may be an external fluid inlet adapted to convey fluid from an external supply to the fluid transportation means.

Preferably the fluid transportation means may include a 3-way joint mounted on the vehicle; a first spigot of the 3-way joint connected by fluid conveyance means to the external fluid inlet; a second spigot of the 3-way joint connected by fluid conveyance means with one or more fluid reservoirs of the one or more disc brake mechanisms and a third spigot of the 3-way joint connected by fluid conveyance means with one or more fluid reservoirs of the one or more disc brake mechanisms.

Preferably the fluid conveyance means connected with the one or more fluid reservoirs may include valves adapted to allow independent control of the flow of fluid to the one or more fluid reservoirs of the one or more disc brake mechanisms.

Preferably the external fluid inlet may be adapted for connection to a hose.

Preferably the brake flushing system may further include one or more inlets for a fluid additive.

Preferably the brake flushing system may further include one or more fluid additive reservoirs.

In an alternative embodiment of the second aspect of the invention the fluid supply means may include a fluid tank mounted on the vehicle.

Preferably, the fluid supply means may further include a pump adapted to pump fluid from the tank to the inlet means of the or each brake flushing means, and control means to control pump operation.

Preferably the fluid transportation means may include a 3-way joint mounted within the vehicle; a first spigot of the 3-way joint connected by fluid conveyance means to the fluid tank; a second spigot of the 3-way joint connected by fluid conveyance means with one or more fluid reservoirs of the one or more disc brake mechanisms and a third spigot of the 3-way joint connected by fluid conveyance means with one or more fluid reservoirs of the one or more disc brake mechanisms.

Preferably the fluid conveyance means connected with the one or more fluid reservoirs may include valves adapted to allow independent control of the flow of fluid to the one or more fluid reservoirs of the one or more disc brake mechanisms.

Preferably the pump control means may be a switching mechanism. Preferably the pump control means may include a timing mechanism allowing automated operation of the pump for a pre-selected time period.

Preferably the timing mechanism may be a multi-stage timing mechanism allowing programmed activation of the brake flushing system for multiple pre-selected time periods.

Preferably the pump control means may be capable of activation by the driver in a towing vehicle whilst towing the trailer.

According to a further aspect of the invention there is provided a brake flushing means substantially as herein described and with reference to the accompanying drawings.

According to a further aspect of the invention there is provided a brake flushing system substantially as herein described and with reference to the accompanying drawings.

Other aspects for the invention may become apparent from the following description which is given by way of example only and with reference to the accompanying drawings.

### BRIEF DESCRIPTION OF THE DRAWINGS

The invention will now be described by way of example only and with reference to the drawings in which:

FIG. 1: is a front view of the nozzles and reservoir of the invention in one preferred form for use with a disc brake mechanism,

FIG. 2: is a rear view of the nozzles and reservoir of FIG. 1,

FIG. 3: is an elevated perspective end view of the nozzles and reservoir of FIG. 1,

FIG. 4: is a front view along the axle towards a disc brake mechanism showing the nozzles and reservoir of the invention in a preferred form,

FIG. 5: is an end view of the disc brake mechanism, and nozzles and reservoir of FIG. 4,

FIG. 6: is an inverted end view of the disc brake mechanism, and nozzles and reservoir of FIG. 4,

FIG. 7: is a cross-sectional plan view of a towing trailer according to the manual embodiment of the invention,

FIG. 8: is a cross-sectional plan view of a towing trailer according to the semi-automated embodiment of the invention,

FIG. 9: is a front side view of the brake flushing means reservoir, in another preferred form, illustrating the reservoir inlet and nozzle placement sites,

FIG. 10: is a top view of the reservoir of FIG. 9,

FIGS. 11a/b: are end views of the reservoir of FIG. 9,

FIG. 12: is a bottom view of the reservoir of FIG. 9, and

FIG. 13: is a rear side view of the reservoir of FIG. 9.

### DETAILED DESCRIPTION OF THE INVENTION

The invention relates to a system which is designed to flush fluid over componentry of a braking system of a vehicle, and more specifically a disc brake mechanism, which has been, or which will be, exposed to lake water, sea water, marine conditions or other corrosive conditions. The invention is described with reference to a braked boat trailer having two brakes but it is envisaged that braked boat trailers with four brakes, and other vehicles having disc brake mechanisms may benefit from such a system, including cars and trucks. The invention may also have particular application to vehicles that travel in countries where salt is added to the road surfaces in winter or, more generally, where any corrosive substance is found on road surfaces.

Two primary embodiments of the invention are discussed. The first relates to a manually activated brake flushing system. This is designed for the manual attachment of a, for example, garden hose, to the fluid inlet of the flushing system. The flushing fluid in most cases will be fresh water; the source of the water into the system being directly from a domestic water source via the hose.

In operation it is envisaged that the trailer will be parked beside such a water source, the hose connected to the fluid inlet and, by turning the tap the water is carried directly to the disc brake mechanisms through the system of the invention, and the region flushed.

In the second embodiment of the invention there is provision for carrying out fluid flushing whilst the vehicle is moving, and/or when the vehicle is not in the vicinity of any external water source. This is possible as the embodiment includes a fluid tank mounted on the trailer. The operator of the system can pump fluid from this tank to the disc brake mechanisms of the trailer to flush the region at any time, including whilst driving.

Both of these embodiments of the invention have similar componentry in the region of each brake of the trailer, as shown in the Figures.

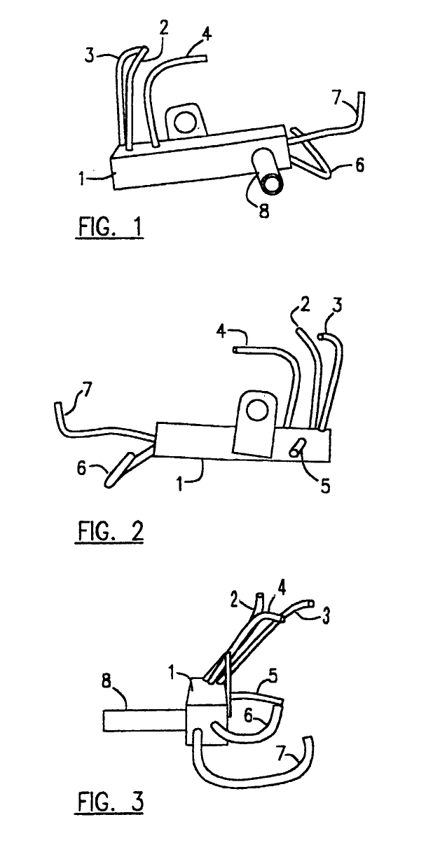

FIGS. 1, 2 and 3 show principal components of the invention, which exist in the region of the disc brake mechanism—a reservoir 1, nozzles 2-7 integrally formed and extending from the reservoir 1 and the reservoir inlet 8. The flushing fluid is transported to the reservoir 1 through the reservoir inlet 8 and then to specific components of the disc brake mechanism via the nozzles 2-7. In the case of the embodiment shown in FIGS. 1 to 3 the nozzles 2-7 are specifically designed to convey water to components of a generic disc brake mechanism.

In use reservoir inlet 8 is connected to the central fluid transportation means of the system (not shown), which conveys the flushing water from an external source (in the manual embodiment) or from the fluid tank and pump (in the semi-automated system). It will be appreciated that the reservoir inlet 8 may be positioned at any number of sites on the reservoir body without departing from the scope or spirit of the invention.

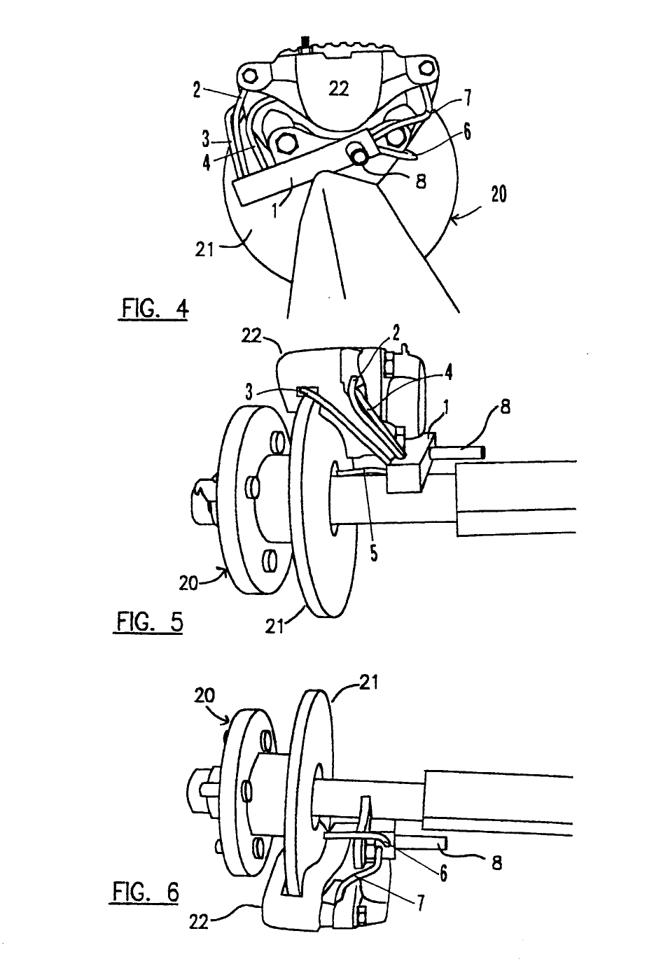

With reference to FIGS. 4, 5 and 6 the components of the brake flushing system of FIGS. 1 to 3 are shown in relation to the disc brake mechanism, generally 20. The disc brake mechanism 20 includes the disc 21 and brake caliper housing 22, to which the reservoir 1 is attached as shown most clearly in FIG. 4. As can be seen in FIGS. 4-6 the nozzles 2-7 are directed towards specific components of this disc brake mechanism 20. Particularly, a first nozzle 2, is directed towards the caliper housing slide and seal; a second nozzle 3 is directed towards the rear side of the brake pad and disc, supplying a source of fluid to this area generally, a third nozzle 4 is directed towards the piston and piston seal, a fourth nozzle 5 is directed towards the disc, and around the wheel bearing seal, a fifth nozzle 6, is directed towards the rear, bottom and side of the piston and piston seal, and a sixth nozzle 7 is directed towards the side of the caliper housing.

In relation to both the manual and semi-automatic embodiments, flushing water is transported through the central fluid transportation system and enters the fluid reservoir 1 through the inlet duct 8. The water exits the reservoir through the nozzles 2-7 thereby flushing each of the above identified components with water.

Further, this system provides water generally to the whole region of the disc brake mechanism by run-off. These flushing processes facilitate the removal of foreign solutions or residues, such as salt residue, which may otherwise cause the deterioration of the braking mechanism.

In some instances, and in particular with the manually operated system, flushing of the area may not be possible immediately after exposure of the disc brake mechanisms to salt water conditions. Thus the invention also considers as an additional option one or more separate chemical reservoir which allows addition of chemicals to the water flow, to improve removal of dried residues, or even as a source of metal protection solution.

As the invention may be used with vehicles having different characteristics, including the number of brakes and the brake geometry, the overall appearance of the brake flushing means will vary. It will be appreciated, however, that the general purpose of the invention is to flush important components of a disc brake mechanism with fluid, and to achieve this by directing a plurality of nozzles from a central reservoir attached to, attachable to or integrally formed in, a disc brake mechanism.

It is to be understood that the nozzles may be interconnectable with the reservoir 1. This provides an option to vary the position of the nozzles, according to the specific disc brake mechanism geometry of the vehicle. The reservoir unit may have available alternative nozzle placement sites.: The nature of the disc brake mechanism geometry dictates whether the alternative placement sites are used. Unused nozzle placement sites may be sealed by welding or by a plug; for example rubber seals.

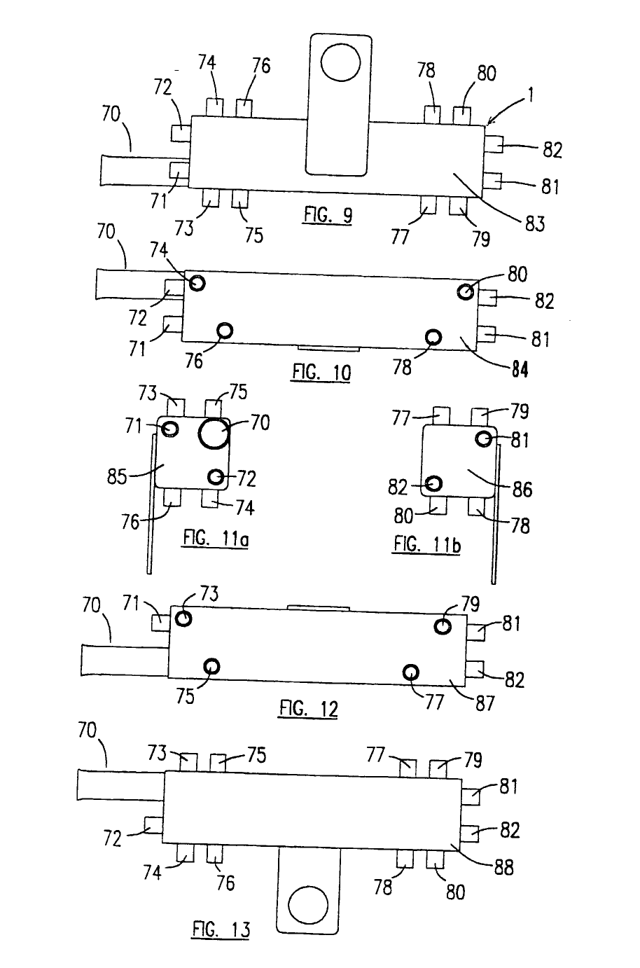

FIGS. 9-13, represent an alternative form of the reservoir 1. It will be appreciated that in this preferred form, the nozzles are interconnectable with the reservoir. The reservoir inlet 70 is positioned in alignment with the reservoir body; extending from the reservoir face 85 (illustrated in FIG. 11a). Nozzle placement sites 71-82 facilitate the engagement of the nozzles to the reservoir 1.

In this preferred embodiment side faces 83 and 88, have no nozzle placement sites, facilitating positioning of the reservoir close to the disc brake mechanism. The top face 84 has four nozzle placement sites (74, 76,78 and 80), as does the bottom face 87 (73, 75, 77 and 79). The end faces 85 and 86, each have two nozzle placement sites. There may be more or fewer nozzle placement sites on the reservoir, and their specific locations may be adjusted. In the preferred embodiment of FIGS. 9-13 they are all located towards the opposite longitudinal ends of the reservoir to enable the brake flushing device to be most adaptable for disc brake mechanisms of differing configurations.

The nozzles themselves may be manufactured in a specific design, intended for a certain disc brake mechanism geometry. Alternatively, the nozzles may be composed of a pliable material, which would allow the purchaser of the device (a manufacturer or individual vehicle owner) to mould the nozzles into an appropriate shape, complimentary to the individual geometry of their disc brake mechanism.

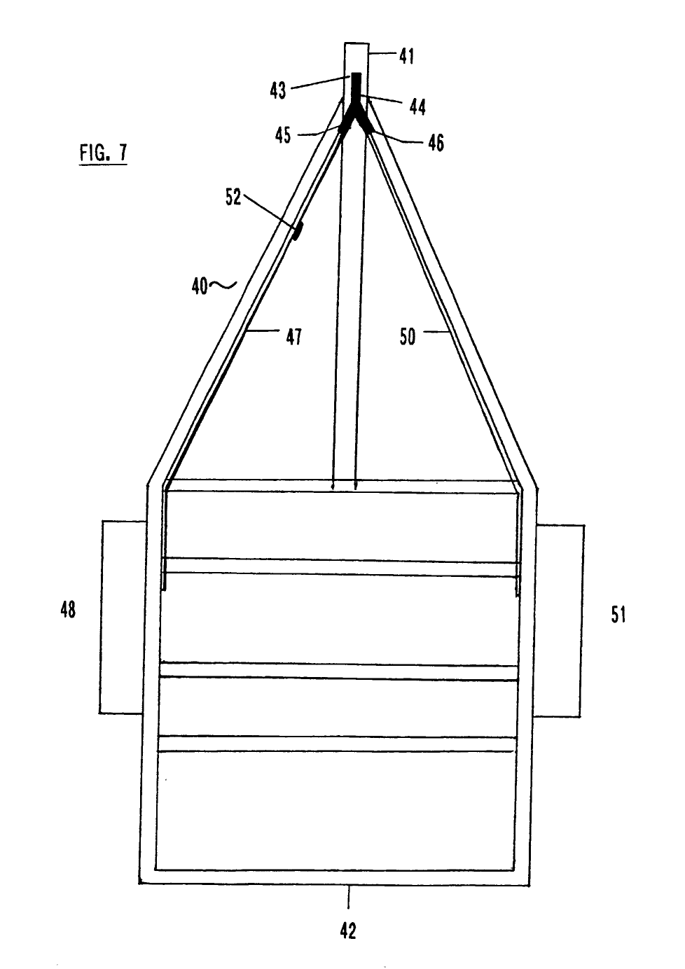

FIG. 7 provides a cross-sectional plan view of a towing trailer according to the manual embodiment of the system. In FIG. 7 the towing trailer, generally 40 has a tow coupling end 41 and a loading end 42. The fluid inlet 43 of the brake flushing system is shown at the tow coupling end 41 of the trailer 40. This is attached to a Y-joint 44 also proximal to the tow coupling end 41 of the trailer 40.

The Y-joint 44 includes a first arm 45 and a second arm 46. The first arm 45 is connected by hose 47 to the reservoir inlet 8 (not shown) of the reservoir 1 (not shown) of a first wheel 48. The second arm 46 of the Y-joint 44 is connected via a second hose 50 to the reservoir inlet 8 (not shown) of the reservoir 1 (not shown) of a second wheel 51.

This particular embodiment as discussed previously may include an optional chemical reservoir 52. This can be mounted at any point on the trailer 40.

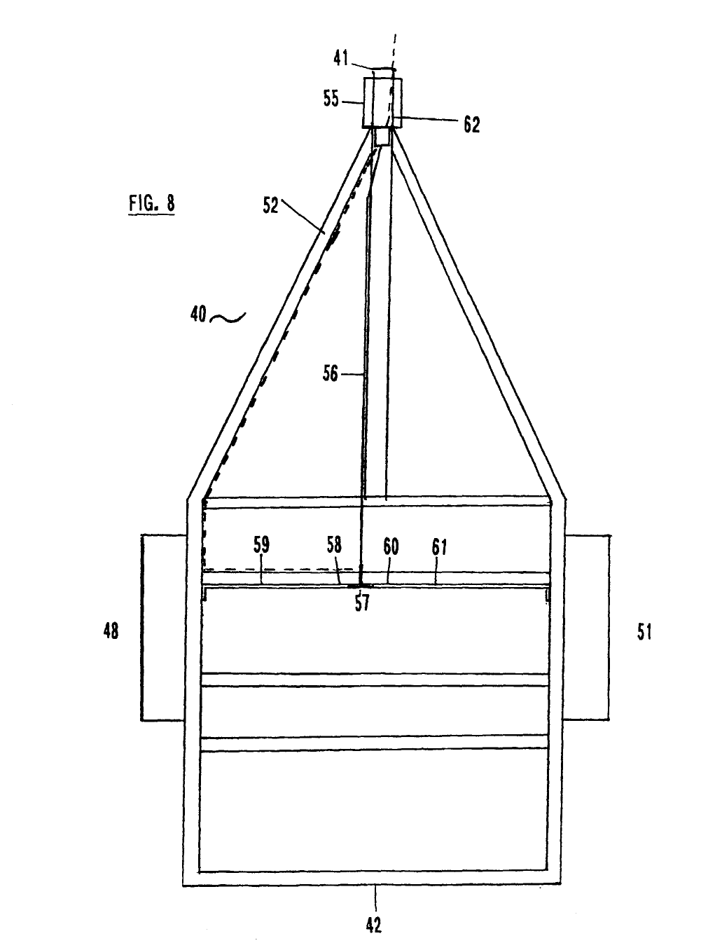

The semi-automated embodiment of the invention is illustrated in FIG. 8. There is provided a trailer shown generally 40 having wheels 48 and 51, a tow coupling end 41 and loading end 42. The fluid tank 55, as the source of flushing fluid is affixed to the trailer 40. In this representation it is affixed at the tow coupling end 41. The tank 55 is connected via hosing 56 to a T-joint 57 mounted centrally on the trailer 40. The first arm 58 of the T-joint 57 connects via hosing 59 with the reservoir inlet 8 (not shown) of the reservoir 1 of wheel 48. Connected to the second arm of the T-joint 60 is a further hose 61 connected to the reservoir inlet 8 (not shown) of the reservoir 1 of wheel 51. Again this embodiment may be provided with an optional chemical reservoir 52 mounted on the trailer 40. The pump 62 for pumping fluid from the tank 55 is located proximal to the tank 55 at the tow coupling end 41 of the trailer 40.

The pump 62 of this embodiment is fitted with a timing mechanism (not shown). This timing mechanism allows for pre-programmed use of the flushing system for a given period of time. Ideally it is envisaged that this timing mechanism is at least a three-stage mechanism. This allows for use of the flushing system at least in three stages.

One example scenario where such functionality would be used is as follows: just prior to exposure to salt water the disc brake mechanisms of the trailer can be flushed for a pre-programmed length of time for cooling purposes. This in itself will reduce the potential for damage of salt water on the braking componentry. Secondly, as soon as the disc brake mechanisms have been exposed to the salt water when offloading a boat, a second flushing stage occurs, washing the disc brake regions of salt water. The final timed stage occurs once the boat has been re-loaded upon the trailer, and the disc brake mechanisms have been exposed once again to the salt water.

In the preceding descriptions, sections of fluid transportation means of the system have been generally described as sections of hosing. However, the transportation means may be any other suitable conveyance means such as piping, as would be envisaged by one skilled in the art.

Provision has been made for instances when flushing of both disc brake mechanisms is not required, or where the water pressure is low (for the manual embodiment) making efficient flushing difficult. Accordingly the Y-joint 44 (manual embodiment) or T-joint 57 (semi-automated embodiment) may be fitted with on/off values at the arms to allow independent flushing of each wheel if desired.

Furthermore, for vehicles having four disc brake mechanisms it may be that a number of joints of different geometries are employed, and on/off values included where appropriate to allow independent flushing.

In one preferred embodiment, the reservoir may be bolted to the disc brake caliper, thus attaching the brake flushing means to the disc brake mechanism. It will be appreciated that, although disc brake caliper systems are somewhat generic in design, in some cases, where a unique disc brake caliper is involved, an adapter may be necessary to ensure the reservoir is mounted in the correct position.

The reservoir of the embodiment of FIGS. 1-6 and 9-13 may be provided as a kit-set, together with a plurality of nozzles and plugs. The nozzles may be of fixed dimension and shape, or may be straight but sufficiently pliable to be bent into a preferred shape.

A further embodiment of the invention which is contemplated is the integration of brake flushing features into disc brake componentry upon manufacturing or thereafter. It is envisaged that an integrally formed fluid reservoir having a number of nozzles may be integrated into the caliper housing of a disc brake system for example. This would allow connection of piping or tubing as a water transportation means at a later time and its use as a brake flushing system generally as described above.

Where in the foregoing description reference has been made to elements or integers having known equivalents, then such equivalents are included as if they were individually set forth.

Although the invention has been described by way of example and with reference to particular embodiments, it is to be understood that modifications and or improvements may be made without departing from the scope or spirit of the invention.

1. A brake flushing means for a vehicle disc brake mechanism, the brake flushing means including a plurality of nozzles adapted to direct a flushing fluid at selected components of the disc brake mechanism, and inlet means adapted to receive flushing fluid and convey said fluid to the nozzles.

2. A brake flushing means according to claim 1, wherein the brake flushing means further includes a fluid reservoir between the inlet and the nozzles.

3. A brake flushing means according to claim 2, wherein the nozzles are integrally formed with, or affixed to, the reservoir.

4. A brake flushing means according to claim 2, wherein the fluid reservoir includes nozzle placement sites to which the nozzles are affixed or engaged.

5. A brake flushing means according to any one of the previous claims, wherein the nozzles are made from a pliable material allowing them to be shaped to direct flushing fluid to the selected components of a selected disc brake mechanism.

6. A brake flushing means according to any one of the previous claims, wherein the selected components of the disc brake mechanism include one or more of: the piston, the piston seal, the slides, the seal around the slides, the seal around the inner wheel bearing, the seal around the caliper housing slides.

7. A brake flushing means according to any one of the previous claims, wherein the fluid reservoir is formed integrally with the disc brake mechanism.

8. A brake flushing means according to any one of claims 1 to 6, wherein the brake flushing means further includes attachment means adapted to attach the fluid reservoir to the brake mechanism.

9. A brake flushing system for a vehicle having one or more disc brake mechanisms, wherein the brake flushing system includes a brake flushing means according to any one of claims 1 to 8, associated with the or each disc brake mechanism, fluid supply means at an accessible point on the vehicle, and fluid transportation means to transport fluid from the fluid supply means to the inlet means of the or each brake flushing means.

10. A brake flushing system according to claim 9, wherein the vehicle is a trailer, having a tow coupling end and a loading end;
and including one or more disc brake mechanisms.

11. A brake flushing system according to either claim 9 or claim 10, wherein the fluid supply means includes an external fluid inlet adaptable to convey fluid from an external supply to the fluid transportation means.

12. A brake flushing system according to any one of claims 9 to 11, wherein the fluid transportation means includes a 3-way joint mounted on the vehicle; a first spigot of the 3-way joint connected by fluid conveyance means to the external fluid inlet;
a second spigot of the 3-way joint connected by fluid conveyance means with one or more fluid reservoirs of the one or more disc brake mechanisms and a third spigot of the 3-way joint connected by fluid conveyance means with one or more fluid reservoirs of the one or more disc brake mechanisms.

13. A brake flushing system according to claim 12, wherein the fluid conveyance means, connectable with the one or more fluid reservoirs, includes valves adapted to allow independent control of the flow of fluid to the one or more fluid reservoirs of the one or more disc brake mechanisms.

14. A brake flushing system according to any one of claims 9 to 13, wherein the brake flushing system further includes one or more inlets for a fluid additive.

15. A brake flushing system according to claim 14, wherein the brake flushing system further includes one or more fluid additive reservoirs.

16. A brake flushing system according to either claim 9 or claim 10, wherein the fluid supply means includes a fluid tank mounted on the vehicle.

17. A brake flushing system according to claim 16, wherein the fluid supply means includes a pump adaptable to pump fluid from the tank to the inlet means of the or each brake flushing means, and control means to control pump operation.

18. A brake flushing system according to claim 17, wherein the fluid transportation means includes a 3-way joint mounted within the vehicle; a first spigot of the 3-way joint connected by fluid conveyance means to the fluid tank; a second spigot of the 3-way joint connected by fluid conveyance means with one or more fluid reservoirs of the one or more disc brake mechanisms and a third spigot of the 3-way joint connected by fluid conveyance means with one or more fluid reservoirs of the one or more disc brake mechanisms.

19. A brake flushing system according to claim 18, wherein the fluid conveyance means, connectable with the one or more fluid reservoirs, includes valves adapted to allow independent control of the flow of fluid to the one or more fluid reservoirs of the one or more disc brake mechanisms.

20. A brake flushing system according to claim 17, wherein the pump control means includes a timing mechanism allowing automated operation of the pump for a pre-selected time period.

21. A brake flushing system according to claim 20, wherein the timing mechanism is a multi-stage timing mechanism allowing programmed activation of the brake flushing system for multiple pre-selected time periods.

22. A brake flushing system according to any one of claims 17 to 21, wherein the pump control means is capable of activation by a driver in a towing vehicle whilst towing the trailer.

23. A brake flushing means substantially as herein described and with reference to the accompanying drawings.

24. A brake flushing system substantially as herein described and with reference to the accompanying drawings.
